(19) United States
(12) Patent Application Publication
(10) Pub. No.: US 2001/0056394 A1
(43) Pub. Date: Dec. 27, 2001

(54) Transaction system

(76) Inventor: Hiroshi Hamada, Tokyo (JP)

Correspondence Address: STAAS & HALSEY LLP, 700 11TH STREET, NW, SUITE 500, WASHINGTON, DC, 20001, US

(21) Appl. No.: 09/729,319

(22) Filed: Dec. 5, 2000

(30) Foreign Application Priority Data
Jun. 23, 2000 (JP) 2000-189237

(51) Int. Cl. G06F 17/60

(52) U.S. Cl. 705/37; 705/26

(57) ABSTRACT

The object of the present invention is to provide a transaction method that increases the desire of persons to participate therein. There is provided a product transaction method that executes product auctions over a communication network, wherein information regarding a product to be sold at auction is received from a product registrant, and this information is stored, an option representing the right to purchase from the product registrant at a preset price the product to be sold at auction, and to sell the product to the winning bidder at the winning bid price, is sold to a prospective option purchaser via the communication network, an auction of the product is executed through presenting the stored product information via the communication network and receiving bids, and where the purchaser of the option requests that the option be exercised, processing is carried out in accordance with the terms of the option.

### BACKGROUND OF THE INVENTION

1. Field of the Invention

The present invention relates to a transaction system, and more particularly to a transaction system that carries out auctions and reverse auctions of products.

2. Description of the Related Art

Products have been sold at auctions for many years, but ordinary consumers have generally not participated in such auctions. However, with the spread of the personal computer (PC) and the Internet, Internet-based auctions have become increasingly common.

An auction using the Internet will now be briefly explained. A person having a product that he would like to auction registers the product information with the auction site. This product information is displayed on the auction Web site, indicating that the product is to be sold at auction, and the auction is performed over a fixed auction period. In an auction, the initial auction price, i.e., the minimum bid price, is generally set by the product seller. A person wanting to bid on the product may do so by posting a bid price at any time with the auction site via the Internet. The auction site posts the offered bid price immediately on the Web site, and waits for more bids. When a plurality of persons make bids in this fashion, the person offering the highest bid within the preset period becomes the winning bidder for the product. The results of the auction are then displayed on the Web site. The product is then delivered and the purchase price is paid.

On the other hand, in addition to normal auctions, auctions called ‘reverse auctions’ have recently been carried out on the Internet as another type of transaction system. A reverse auction differs from a normal auction in that, whereas in a normal auction persons wanting to buy a product make the bids, in a reverse auction persons wanting to sell the product make the bids. Specifically, a reverse auction is carried out in the following manner. A person wanting to obtain a particular product registers the desired product with the auction site together with the minimum conditions of purchase. The product information is displayed on the Web site of the auction site as pertaining to a product that will be the subject of a reverse auction, and the reverse auction is carried out over a fixed auction period. Sellers of the product make bids by offering a bid price regarding the product at any time on the auction site via the Internet. The auction site immediately posts the offered bid price on the Web site and waits for more bids. When a plurality of persons make bids in this fashion, the person offering the lowest bid within the preset period becomes the winning bidder. The results of the auction are then displayed on the Web site. The product is then delivered and the purchase price is paid. This type of reverse auction is disclosed in, for example, U.S. Pat. No. 5,794,207.

In the prior art, auctions and reverse auctions are carried out over the Internet via communication networks, but because the persons that participate in these transactions are limited to persons that register the product and persons that want to bid on the product, persons that do not fit these categories do not have the opportunity to participate. Consequently, it is difficult to vitalize these types of auction-based transaction systems.

### SUMMARY OF THE INVENTION

In view of the foregoing, it is an object of the present invention to provide a transaction system that increases the desire of persons to participate therein, and is not limited to ordinary auctions and reverse auctions.

It is another object of the present invention to provide a transaction system that enables simplification of the system of payment for a sold product, and leads to more lively transactions.

According to one aspect of the present invention, for achieving the above-mentioned objects, there is provided a transaction system that includes a product registration processing unit that receives over a communication network and stores information from a product registrant regarding a product to be sold through auction, an option processing unit that sells to prospective option purchasers over a communication network an option providing the right to purchase from the product registrant at a predetermined price the product to be the subject of the auction and thereafter sell the product to the winning bidder at the winning bid price, and an auction processing unit that executes an auction of the product by posting over a communication network product information stored by the product registration processing unit and by receiving bids, and, where the option purchaser elects to execute the option right, performs processing in accordance with the terms of the option.

According to another aspect of the present invention, there is provided a transaction system that includes a product registration processing unit that receives over a communication network and stores information from a product registrant regarding a product to be purchased through a reverse auction, an option processing unit that sells to prospective option purchasers over a communication network an option providing the right to purchase at the bid price the product to be the subject of the reverse auction and sell the product to the product registrant at a predetermined price, and a reverse auction processing unit that executes a reverse auction of the product by posting over a communication network product information stored by the product registration processing unit and by receiving bids, and, where the option purchaser elects to execute the option right, performs processing in accordance with the terms of the option.

Consequently, the transaction system of the above aspects sells options in an auction format via the option processing unit.

The above and further objects and novel features of the invention will more fully appear from the following detailed description when the same is read in connection with the accompanying drawings. It is to be expressly understood, however, that the drawings are for purpose of illustration only and are not intended as a definition of the limits of the invention.

### BRIEF DESCRIPTION OF THE DRAWINGS

FIG. 1 is a drawing to explain the transaction system in regard to the present invention;

FIG. 2 is a flow chart to explain a transaction in regard to the present invention;

FIG. 3 is a flow chart to explain a transaction in regard to the present invention;

FIG. 4 is a drawing to explain a transaction in regard to the present invention;

FIG. 5 is a drawing to explain membership registration and product registration in regard to the present invention;

FIG. 6 is a drawing to explain option bidding in regard to the present invention;

FIG. 7 is a flow chart to explain option bidding in regard to the present invention;

FIG. 8 is a drawing to explain registration of option purchasers in regard to the present invention;

FIG. 9 is a drawing to explain the resale of an option in regard to the present invention;

FIG. 10 is a drawing to explain the exercise of an option in regard to the present invention;

FIG. 11 is a drawing showing an example of the screen display in the event of a winning bid in regard to the present invention;

FIG. 12 is a drawing to explain winning bidder registration in regard to the present invention;

FIG. 13 is a drawing to explain payment in regard to the present invention;

FIG. 14 is a drawing to explain payment in regard to the present invention;

FIG. 15 is a drawing to explain transactions using the transaction system pertaining to the present invention;

FIG. 16 is a drawing to explain winning bidder registration in regard to the present invention;

FIG. 17 is a drawing to explain winning bidder registration in regard to the present invention; and

FIG. 18 is a drawing to explain payment in regard to the present invention.

FIG. 19 is a drawing to explain payment in regard to the present invention.

### DETAILED DESCRIPTION OF THE PREFERRED EMBODIMENTS

A preferred embodiment of the present invention will now be described in detail with reference to the accompanying drawings.

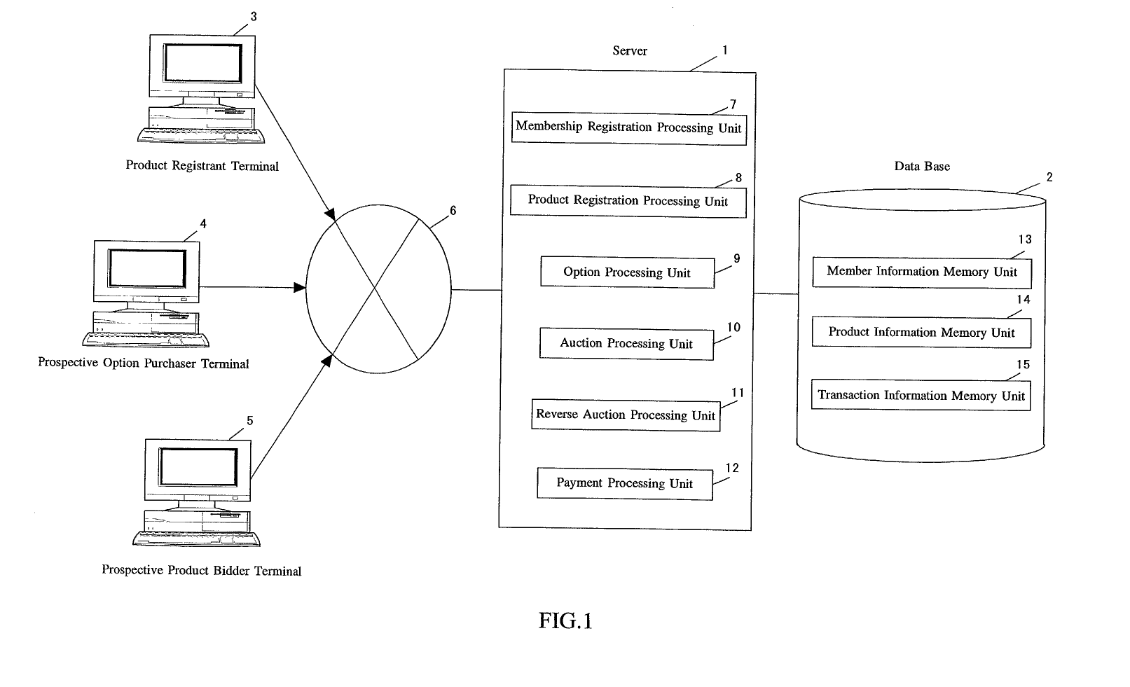

FIG. 1 is a drawing to explain the transaction system pertaining to the present invention. Products sold using this transaction system may include, in addition to various types of products such as wall clocks, digital cameras and food products, services such as airline tickets, movies, or baseball games. Therefore, in the explanation of the embodiments of the present invention provided below, ‘product’ is not limited to its meaning in the narrow sense, but includes services as well.

In FIG. 1, reference numeral 1 means a server that executes a prescribed processing on a computer (client) connected via a communication network, and includes a membership registration processing unit 7, a product registration processing unit 8, an option processing unit 9, an auction processing unit 10, a reverse auction processing unit 11, and a payment processing unit 12.

In FIG. 1, reference numeral 2 means a database connected to the server 1, and includes a memory that stores various information in response to commands from each processing unit in the server 1. The database 2 includes a member information memory unit 13, a product information memory unit 14, and a transaction information memory unit 15. Information about members of this transaction system is stored in the member information memory unit 13, and is classified into the categories of product registrants, prospective option purchasers, and prospective product bidders. Product-related information including information and purchase conditions regarding a product comprising the subject of an auction or a reverse auction is stored in the product information memory unit 14. Information regarding transaction status, transaction results and payment for auctions and reverse auctions is stored in the transaction information memory unit 15.

In FIG. 1, reference numeral 3 means a product registrant terminal having a display means such as a display, and comprises a computer on which is installed a browser that receives HTML (Hypertext Markup Language) data and displays this data on the display means. Here, the term ‘product registrant’ refers to the person that, in the case of an auction, sells the product after the product is registered and the winning bid is posted, or in the case of a reverse auction, establishes conditions for the purchase of the product and purchases the product after the winning bid is posted.

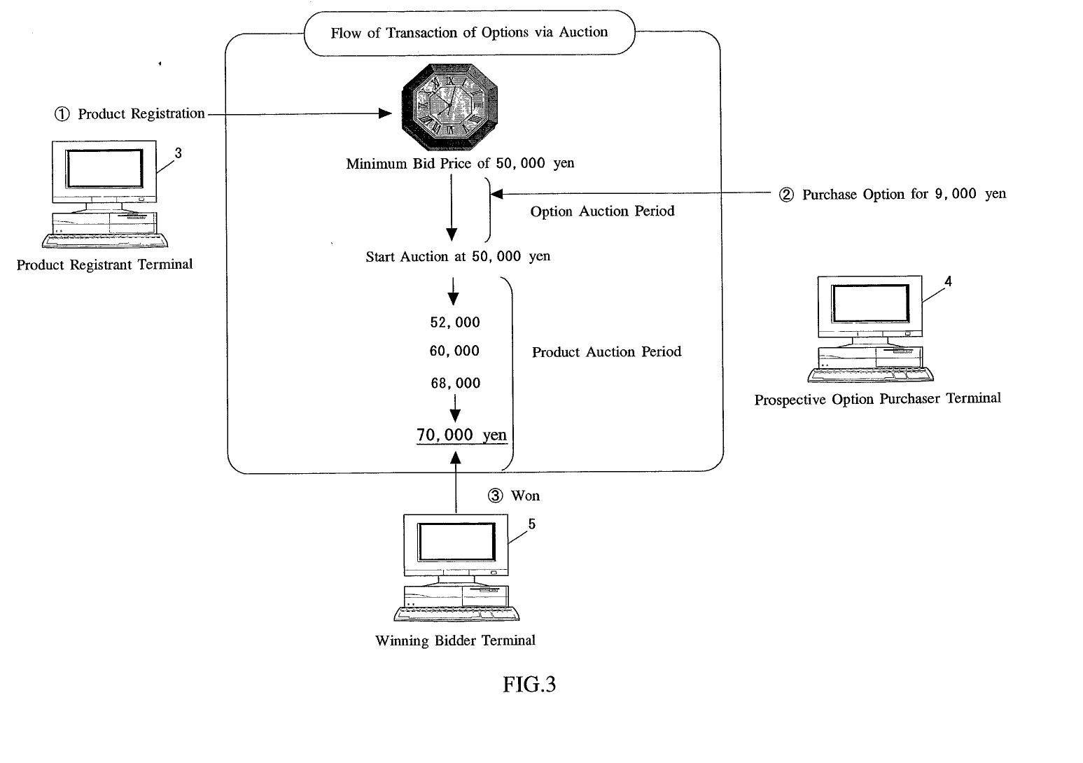

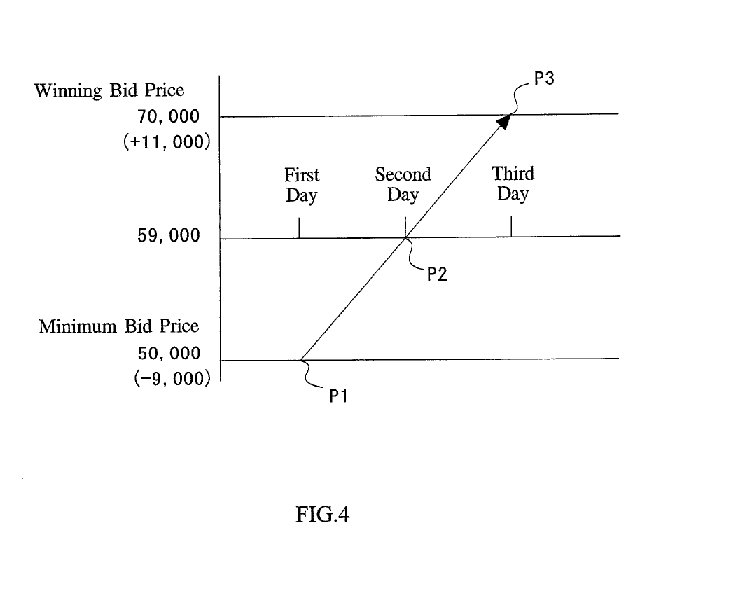

In FIG. 1, reference numeral 4 means a prospective option purchaser terminal having at least a display means and a browser, like the product registrant terminal 3. An option, in the case of an auction, is the right to buy the product at a preset price and then sell the product to the winning bidder at the winning bid price. In the case of a reverse auction, an option is the right to buy the product from the winning bidder at the bid price and sell it to the product registrant at a preset price. An option may be exercised even while the auction is underway, or during a prescribed period of time after the auction is completed. When an option is exercised while the auction is underway, the auctioning of the product is terminated and the current highest bid price becomes the winning bid price. The purchase price of the option is sometimes called a premium. Details regarding these matters will be explained below with reference to FIGS. 3 and 4.

In FIG. 1, reference numeral 5 means a prospective product bidder terminal having at least a display means and a browser, like the product registrant terminal 3. In the case of an auction, the term ‘prospective product bidder 5’ refers to the person who purchases the product after the winning bid is posted, while in a reverse auction situation, it refers to the person who sells the product after the winning bid is posted.

In FIG. 1, reference numeral 6 means a communication network such as the Internet or a public network, and may include wire-based or wireless circuits.

The product registrant terminal 3, prospective option purchaser terminal 4 and prospective product bidder terminal 5 can exchange information with the server 1 over the communication network 6, and for the sake of convenience, explanation of the mechanisms and constructions needed to exchange information with a modem, a server of a service provider, a router, etc., is omitted.

The membership registration processing unit 7 in the server 1 serves the function of carrying out processing regarding the membership registration which must be performed in order for a general user to use the transaction system. In this example, in order for a general user to register as a member, the user must register as a product registrant, prospective option purchaser or prospective product bidder. The membership registration processing unit 7 also has the function of transmitting a membership registration Web page to a registrant terminal 3, prospective option purchaser terminal 4 or prospective product bidder terminal 5 where a membership registration request is made over the communication network 6 from a terminal 3, 4 or 5. The member information is input by the general user using an input means such as a keyboard, based on an instruction contained in the Web page. The membership registration processing unit 7 also has a function to extract member information from the information received over the communication network 6 and store it in the member information memory unit 13. It also performs processing to delete or modify member information.

The product registration processing unit 8 has a function to receive and store in the product information memory unit 14 product information input by a product registrant using the terminal 3 and transmitted via the communication network 6.

The option processing unit 9 has a function to perform general processing regarding options, as well as to carry out auctions of options and determine the purchasers of options. It also has a function to receive notifications of option exercise by an option purchaser and transmit notice of such exercise to the auction processing unit 10 or the reverse auction processing unit 11.

The auction processing unit 10 has a function to receive bid information from prospective product bidders from their respective terminals 5 over the communication network 6 and to execute auctions. The auction processing unit 10 also has a function to execute processing in accordance with the terms of the option when an option purchaser has elected to exercise the option while an auction is underway and notice of the exercise has been transmitted from the option processing unit 9.

The reverse auction processing unit 11 has a function to receive bid information from prospective product bidders from their respective terminals 5 over the communication network 6 and to execute reverse auctions. The reverse auction processing unit 11 also has a function to execute processing in accordance with the terms of the option when an option purchaser has elected to exercise the option while a reverse auction is underway and notice of the exercise has been transmitted.

The payment processing unit 12 has a function to execute payment processing as between product registrants, option purchasers and product bidders.

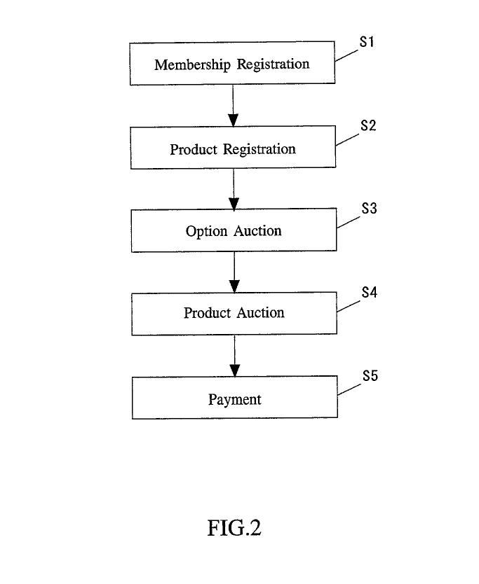

The basic aspects of a product transaction executed via the transaction system pertaining to the present invention will now be explained with reference to FIG. 2. Details regarding each step will be explained below.

First, membership registration for a product transaction pertaining to an embodiment of the present invention is performed (S1). This membership registration is necessary for execution of the product transaction using the transaction system. Product registration is then performed (S2). When this product registration is performed, the transaction system determines the method and the day of the opening of the auction or reverse auction.

After product registration, an option auction is performed (S3). In other words, prospective option purchasers are recruited for a fixed period of time, and the person offering the highest amount is registered as the option purchaser. The product auction is then carried out (S4). The option can be exercised at any time during the auction or during a fixed period of time after the auction period has ended. After the product auction is executed, the price is paid and the product is delivered (S5).

### EMBODIMENT 1

The embodiment 1 of the present invention will now be explained with regard to a transaction system that carries out product transactions via auction. The selling of options via auction will first be summarized with reference to FIG. 3.

First, product information is registered using the terminal 3 used by a product registrant. The system notifies product registrants during or before registration that the system is equipped to carry out option transactions. In this example, the product registrant intends to auction off wall clocks, and registers such information as photographic information regarding the wall clock, a minimum bid of 50,000 yen, and the quantity to be sold. The option auction is then performed, and bid prices are posted by prospective option purchasers using their respective terminals 4. Bid prices are posted by a plurality of prospective option purchasers, and ultimately the prospective option purchaser posting the highest bid price wins the auction. In this example, the option was purchased for 9,000 yen.

Next, the auction of the wall clock comprising the product is carried out. The minimum bid price is the 50,000 yen established by the product registrant. A plurality of prospective bidders post bids using their respective terminals 5. The person posting the highest bid price within the prescribed period becomes the winning bidder, and thereupon purchases the wall clock. In this example, the winning bid is 70,000 yen. If the option purchaser exercises the option within a prescribed period of time after the auction is completed, because the option purchaser has the right to purchase the product for 50,000 yen, he can purchase the product for the total price of 59,000 yen comprising the product purchase price of 50,000 yen and the option purchase price of 9,000 yen, and thereafter sell the product to the winning bidder for the winning bid price of 70,000 yen. Furthermore, when the option purchaser exercises an option in this transaction system, while he can purchase the product at the prescribed price, he is at the same time obligated to sell the product to the winning bidder for the product at the winning bid price.

When this type of transaction is executed, the option purchaser sells for 70,000 yen a product that was purchased for 5,900 yen, enabling him to obtain a profit of 11,000 yen representing the difference between the two prices. At the same time, the product registrant can obtain, in addition to the 50,000 received as the minimum bid price, the option price of 9,000. The selling or exercised of the option makes no difference to the winning bidder for the product, because in any event the winning product bidder makes a winning bid of 70,000 yen and is able to obtain the wall clock in return for a payment of 70,000 yen.

On the other hand, where the option purchaser does not exercise the option before a prescribed period of time elapses after the winning bid is recognized, the option is deemed discarded, and the transaction is handled in the same way as a normal auction executed between the product registrant and the winning bidder. When this occurs, the option purchaser loses the 9,000 yen purchase price of the option. Conversely, the product registrant receives a total profit of 2,900 yen, representing the 9,000 yen from the option purchase price and the 20,000 yen profit on the sale of the product. However, while in theory the option holder can freely choose whether or not to exercise the option, because the option holder can realize a profit of 11,000 yen if the option is exercised, in actual practice the option holder is likely to exercise the option in this case.

The sale of an option through auction will now be explained in more detail with reference to FIG. 4. In this example, the bidding period is three days, the minimum bid price is 50,000 yen, and the winning bid is 70,000 yen. The option represents the right to purchase the product for 50,000 yen, and the price of the option is 9,000 yen. It will be assumed for the sake of convenience that once bidding is begun at the minimum bid price, the bids rise continuously in a linear progression. Moreover, the profit/loss calculations do not take into account such factors as taxes.

On the first day, the auction is opened with a minimum bid price of 50,000 yen (P1 in the drawing). On the second day 5,900 yen (P2 in the drawing) is reached, and on the third and final day, the auction is won with a bid of 70,000 yen (P3 in the drawing). In this scenario, from the option purchaser's perspective, since 9,000 yen was paid to the product registrant as the option purchase price, exercise of the option at the 50,000 minimum bid price would entail a loss equivalent to the 9,000 yen purchase price. If the option is exercised on the second day when the price is 5,900 yen, since the option purchaser can purchase the product for 50,000 yen and sell it for 5,900 yen, there is a profit of 9,000 yen on the product, but this profit is offset by the 9,000 yen purchase price of the option, resulting in a break-even situation. Therefore, in this example, for the option purchaser, a winning bid price of 5,900 yen for the product in the product auction represents the break-even point.

On the other hand, where the winning bid price is 70,000 yen, as can be seen from the fact that a profit of 11,000 yen is received as described above, if the winning bid price for the product is below the 5,900 yen break-even point, the option purchaser suffers a loss, while the higher the winning bid price for the product rises above 5,900 yen, the higher the profit obtained by the option purchaser becomes.

Because the option purchaser need not exercise the option where the winning bid price is low, there can be no loss beyond the 9,000 yen option purchase price. In this example, the option was deemed the right to buy the product at the minimum bid price of 50,000 yen, but this point becomes clearer if it is assumed that the option conferred the right to purchase the product at a price higher than the minimum bid price, such as 70,000 yen. For example, if the option were exercised when the bid price was 55,000 yen, the product transaction would entail a loss of 15,000 yen equal to the difference between 70,000 yen and 55,000 yen, which when added to the option purchase price of 9,000 yen would result in a total loss of 24,000 yen. However, if the option were not exercised, the loss would be limited to 9,000 yen. In other words, an option purchaser can participate in an auction without losing more than the option purchase price.

For a product registrant as well, the transaction system of the present invention offers the advantage of at least providing income in the form of the sale price of the option. For a prospective product bidder, because the auction can end before the expiration of the auction period if the option purchaser decides to exercise the option while the auction is underway, there is a possibility that the prospective product bidder will be able to obtain the product at a comparatively low winning bid price. Furthermore, where the prospective option purchasers must separately pay a commission to participate in this system, the system offers the benefit of reducing the commissions of the product registrant and the prospective product bidders.

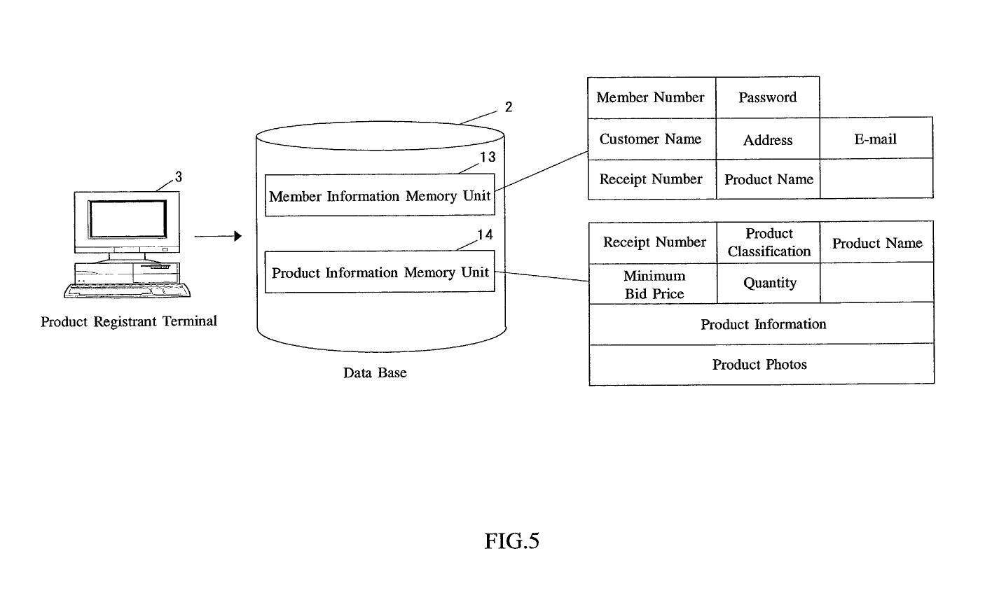

The membership registration and product registration processes will now be explained in more detail with reference to FIG. 5. FIG. 5 discloses the types of information stored in the member information memory unit 13 and the product information memory unit 14 of the database 2.

In the member information memory unit 13 is stored information pertaining to the categories of ‘Member number’, ‘Password’, ‘Customer name’, ‘Address’, ‘E-mail’, ‘Receipt number’ and ‘Product name’. Here, ‘Member number’ refers to numbers such as ‘3948’ that are allocated to members in the order of membership registration. A ‘Password’ is input during the membership registration process by a person seeking to register as a member, using the person's respective terminal 3, 4 or 5, and the input numbers or symbols are set in the membership registration processing unit 7 of the server 1, unless they comprise the person's date of birth or a string of identical numbers, which would be easy for a third party to guess. It is also acceptable if this ‘Password’ is generated by the membership registration processing unit 7 and a prospective registrant is notified of the password during membership registration. ‘Password’ and ‘Member number’ are used during the identity verification process performed to allow a person to use the system. ‘Customer name’ and ‘Address’ refer to the name and address of each prospective member registrant. ‘E-mail’ refers to the e-mail address of a prospective member registrant. ‘Receipt number’ refers to a number assigned by the membership registration processing unit 7 in the order of receipt. The ‘Product name’ is the name of the product, such as ‘wall clock’ in the example above.

Registration in the member information memory unit 13 is performed as follows. First, a prospective member calls up the membership registration page from the home page of the transaction system pertaining to the present invention. The called-up membership registration page is sent to the prospective member registrant's terminal 3 in HTML format from the membership registration processing unit 7 via the communication network 6. The sent membership registration page is displayed on the display or other display means using the browser. For each item of information, the membership registration page contains a blank area in which to enter the information. The prospective member registrant inputs the corresponding information in these blank areas using the keyboard or other input means. When this is done, the prospective member registrant selects whether to register as a product registrant member, an option purchaser member or a product purchaser member. When all of the above data entry is completed, and the user clicks on a button marked ‘Finished’ or ‘Send’, the member information is transmitted to the membership registration processor 7 in the server 1 via the communication network 6. The membership registration processor 7 stores the member information in the member information memory unit 13 by member type. The membership registration processing unit 7 transmits to the terminal 3 of the prospective member registrant via the communication network 6 a notification that the membership registration process has been completed. With this, registration in the membership information memory unit 13 ends.

In the product information memory unit 14 is stored information pertaining to the categories of ‘Receipt number’, ‘Product classification, ‘Product name’, ‘Minimum bid price’, ‘Quantity’, ‘Product information’ and ‘Product photos’. Here, ‘Receipt number’ and ‘Product name’ are identical to the ‘Receipt number’ and ‘Product name’ described with regard to the member information memory unit 13. ‘Product classification’ indicates a higher-order concept than ‘Product name’. ‘Product classifications’ are defined beforehand in the product registration processing unit 8, and a prospective product registrant selects and specifies the product classification from among the defined classifications. The classification of ‘clock’, which is a higher-order concept than ‘wall clock’, is the product classification in this example. The ‘Minimum bid price’ is the price in effect when the auction starts. In this example, it is 50,000 yen. ‘Quantity’ refers to the number of items of the same product to be auctioned. ‘Product information’ is information relating to the product such as product performance and the general retail price. ‘Product photos’ indicates image information such as photographs of the product taken with a digital camera. This category includes dynamic image information as well as static image information.

Registration in the product information memory unit 14 is carried out as follows. First, the product registrant calls up the product registration page from the home page of the transaction system. The called-up product registration page is sent to the product registrant's terminal 3 in HTML format from the product registration processing unit 8 via the communication network 6. The sent product registration page is displayed on the display or other display means using the browser. First, the product registrant enters his member number and password in the product registration page. This information is checked against the information in the member information memory unit 13 by the membership registration processing unit 7. If the member is verified as a member through this check, the product registration processing unit 8 displays the product registration page, in which there are separate blank areas for each item of information to be entered. The product registrant enters information corresponding to these blank areas using a keyboard or other input means. After entering the information, if the product registrant clicks on a button marked ‘Finished’ or ‘Send’, the product information is transmitted to the product registration processing unit 8 via the communication network 6. If the sent product information meets prescribed standards, the product registration processing unit 8 assigns a receipt number and stores the product information and the receipt number in the product information memory unit 14. Information indicating that product registration has been completed is then transmitted from the product registration processing unit 8 to the product registrant's terminal 3 via the communication network 6.

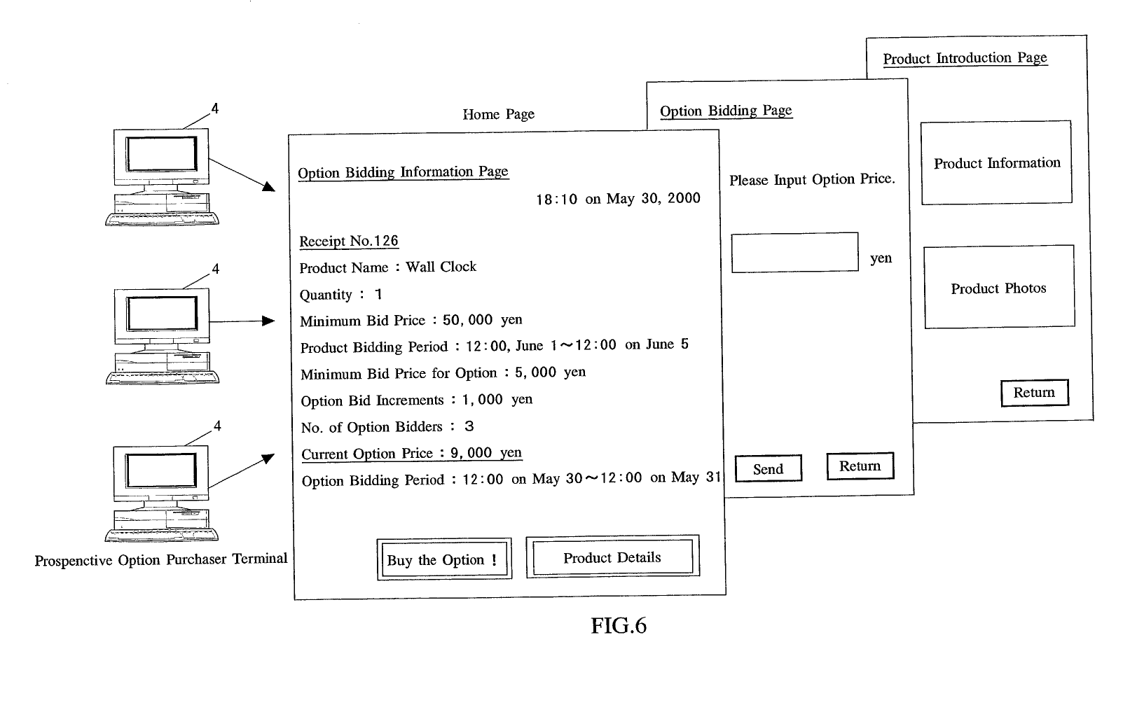

The option auction will now be explained with reference to FIG. 6. The drawing shows an example of a home page screen for an option auction displayed on the display means of the terminal 4 of a prospective option purchaser. This home page includes an option bidding information page, an option bidding page and a product introduction page. The option bidding information page displays information pertaining to the receipt number, the product name, the quantity, the minimum bid price, the product bidding period, the minimum bid price for the option, the option bid increments, the number of option bidders, the current option price and the option bidding period.

Among this information, the receipt number, the product name, the quantity and the minimum bid price are displayed by being called from the information stored in the product information memory unit 14. The product bidding period and the option bidding period are set based on other auctions being run in the auction processing unit 10, and are displayed through the calling of this set information. The minimum option bid price and the option bid increments are set based on the minimum bid price and other information stored in the auction processing unit 10, and are displayed through the calling of this set information. Because the number of option bidders and the current option price are stored in the transaction information memory unit 15 on a continuously updated basis, they are displayed through the calling of information from the transaction information memory unit 15.

At the bottom of the option bidding information page are located two buttons reading ‘Buy the Option!’ and ‘Product Details’. If the prospective option purchaser clicks on the ‘Buy the Option!’ button, that information is transmitted to the option processing unit 9 of the server 1 via the communication network 6. Information pertaining to the option bidding page is then transmitted from the option processing unit 9 to the terminal 4 of the prospective option purchaser via the communication network 6. The option bidding page is then displayed, as shown in FIG. 6.

The prospective option purchaser enters an option bid price into the option bidding page using a keyboard or other input means. When the prospective option purchaser then clicks on the ‘Send’ button located at the bottom of the screen, information regarding the input bid price is transmitted to the option processing unit 9 via the communication network 6. The option processing unit 9 stores the bid price information in the transaction information memory unit 15. In this way, when the transaction information in the transaction information memory unit 15 is modified, the information regarding the number of option bidders and the current option bid price are also updated on the option bidding information page.

If the prospective option purchaser clicks on the ‘Product Details’ button on the option bidding information page, the product introduction page is displayed. This product introduction page displays product-related information and photographs of the product.

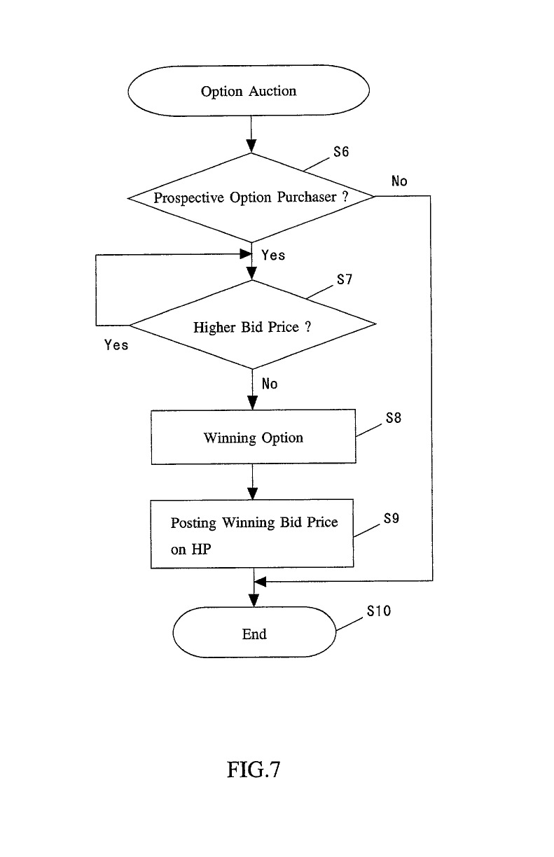

The option auction process will be further explained with reference to the flow chart of FIG. 7. First, the existence of a prospective option purchaser during the option auction bidding period is determined (S6). If there is no prospective option purchaser, the auction is ended (S10). In this case, an auction with no option transaction involved is executed normally.

If there is a prospective option purchaser, it is determined whether or not a bid price has been posted during the bidding term that is higher than any other bid price (S7). If a bid price has been posted during the bidding term that is higher than any other bid price, that price is used as a standard, and it is again determined whether or not a still higher bid has been posted. If no higher price has been posted, the highest bid among the bids received to that point wins the option (S8). The won option and the winning bid price are displayed on the home page (S9). The option auction executed in this fashion thereupon ends (S10).

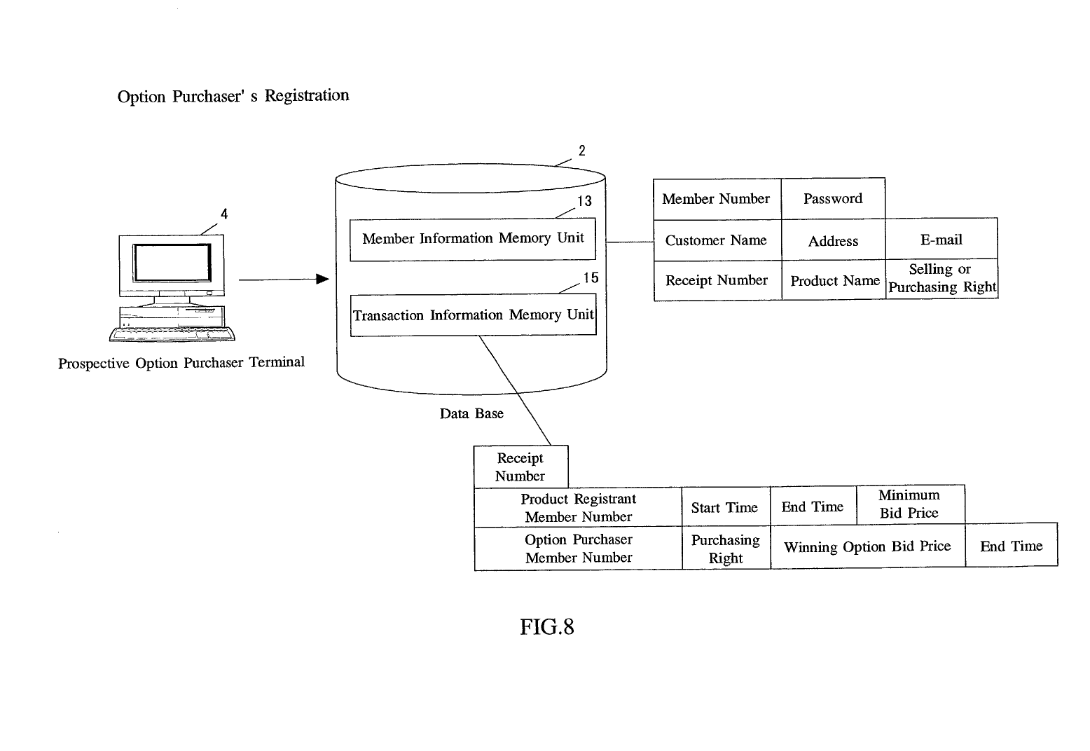

The registration of the person winning the option at the option auction will now be explained with reference to FIG. 8. FIG. 8 shows the detailed contents of the member information memory unit 13 and transaction information memory unit 15 in the database 2. When an option is won, information regarding whether the option confers a purchasing right or a selling right is added to the member information pertaining to the option winner which is stored in the member information memory unit 13. In the case of a normal auction, the fact that the option confers a purchasing right is stored in this information. In the case of a reverse auction, the fact that the option confers a selling right is stored in this information. The ‘Receipt number’ is a number that is assigned upon registration of the product comprising the subject of the won option.

In the transaction information memory unit 15 is stored information regarding the categories of ‘Receipt number’, ‘Product registrant member number’, ‘Start time’, ‘End time’, ‘Minimum bid price’, ‘Option purchaser member number’, ‘Purchasing right’, ‘Winning option bid price’ and ‘End time’. The ‘Product registrant member number’ is the member number of the person that registered the product that is the subject of the option. The ‘Start time’ and ‘End time’ categories on the same row of the table in FIG. 8 comprise information regarding the date and time for the starting and ending of the product auction. The ‘Option purchaser member number’ is the member number of the person that won the option. The ‘End time’ at the end of the table indicates the date and time that the option auction ends. Among this information, the ‘Receipt number’ comprises information that is generated by the product registration processing unit 8 at the time of product registration and is stored in the product information memory unit 14, as described above, while the ‘Product registrant member number’ comprises information that is assigned by the membership registration processing unit 7 at the time of membership registration and is stored in the member information memory unit 13. The ‘Start time’ and ‘End time’ pertaining to the product auction are set based on information regarding other auctions, etc., which is contained in the auction processing unit 10, as described above. ‘Minimum bid price’ refers to information registered by the product registrant, and is stored in the product information memory unit 14. The categories of ‘Option purchaser member number’, ‘Purchasing right’, ‘Winning option bid price’ and ‘End time’ refer to information stored in the transaction information memory unit 15 based on the results of the option auction.

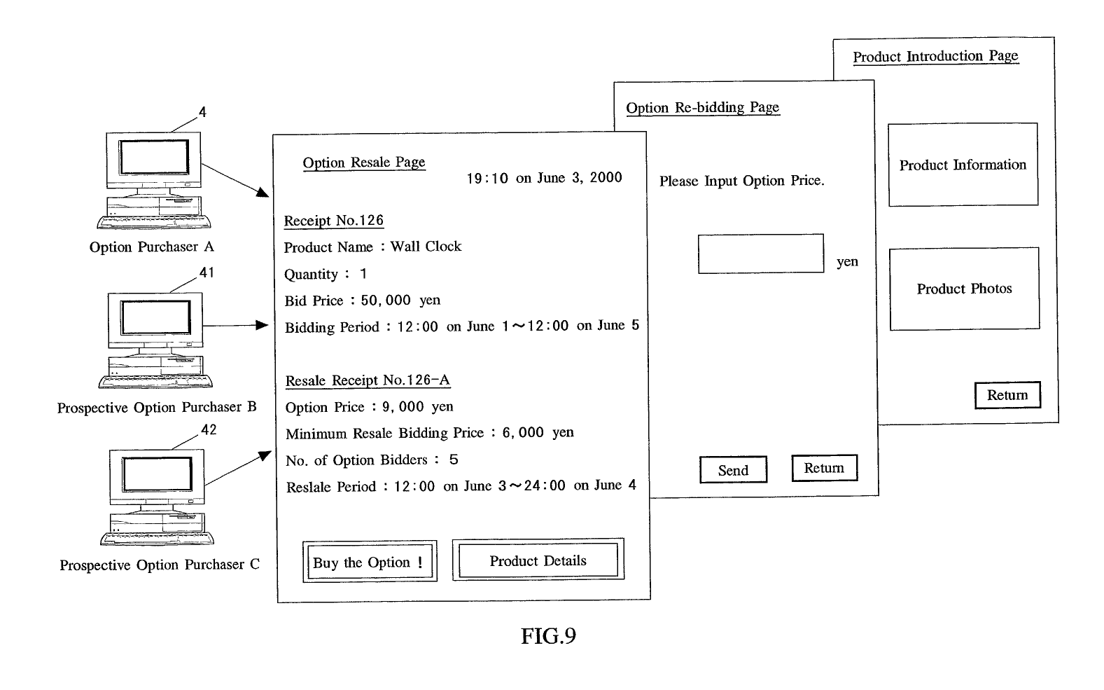

In the transaction system pertaining to this embodiment of the present invention, an option bought at an auction may be resold. The resale of an option will now be explained with reference to FIG. 9. In FIG. 9, the terminal 4 of an option purchaser A, the terminal 41 of a prospective option purchaser B, and the terminal 42 of a prospective option purchaser C are shown. The option resale page is also shown. The option resale page is created by the option processing unit 9 of the server 1 based on transaction information stored in the transaction information memory unit 15. The HTML data in regard to the created option resale page, etc. is transmitted via the communication network 6 to the terminal 4 of the option purchaser A, as well as to the terminals 41 and 42 of the prospective option purchasers B and C, and is displayed on each display using a browser.

The option purchaser A won the option in the option auction with the highest bid of 9,000 yen during the option auction period. Here, a resale of the option purchased by option purchaser A is being offered. Prospective option purchasers B and C are wanting to buy the option.

In the option resale page, product information and product auction information are provided in the part pertaining to receipt number 126. Specifically, the product name, quantity, bid price and bidding period are displayed. The option price, minimum resale bid price, number of option bidders and resale period are displayed in the part pertaining to resale receipt number 126-A. The option price is the winning bid price of the option won by option purchaser A. The minimum resale bid price is a price input by option purchaser A via his terminal 4 for the resale, and comprises the initial bid price for the re-auctioning of the option. The number of option bidders is the number of persons participating in the option auction that was previously concluded. The resale time indicates that the resale is taking place from 12:00 on June 3^{rd} to 24:00 on June 4, while the auction is taking place. As a result, the prospective option purchasers may determine the desirability of purchasing the option in accordance with the status of the product auction.

If the prospective option purchaser decides to purchase the option and clicks on the ‘Buy the Option!’ button using a mouse or other input means, that information is transmitted to the option processing unit 9 of the server 1 via the communication network 6. Information connected to the option resale bidding option page is then transmitted to the prospective option purchaser's terminal 4 from the option processing unit 9 via the communication network 6. An option resale bid page is then displayed, as shown in FIG. 9.

The prospective option purchaser enters an option bid price in the option resale bid page using a keyboard or other input means. When the prospective option purchaser clicks on the ‘Send’ button at the bottom of the page, information regarding the entered bid price is transmitted to the option processing unit 9 via the communication network. The option processing unit 9 then stores the bid price information in the transaction information memory unit 15.

If the prospective option purchaser clicks on the ‘Product Details’ button in the option resale information page, the product introduction page is displayed. In the product introduction page, product-related information and photographs of the product are displayed.

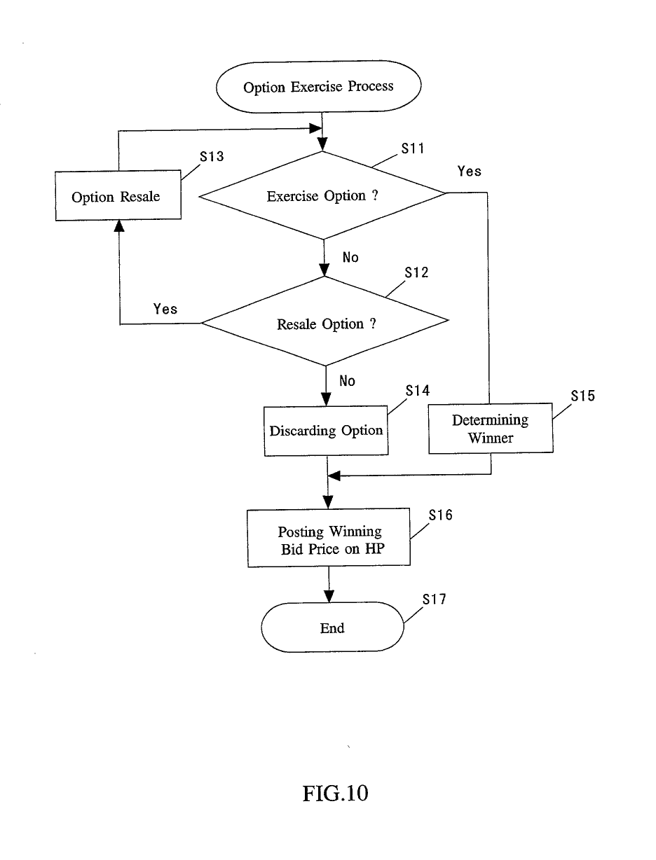

The option exercise process will now be explained with reference to FIG. 10. First, the option purchaser that won and purchased the option at the option auction decides at any time before the product is won at the product auction whether or not to exercise the option (S11). Here, the exercise of the option involves exercising the right to buy the product, buying the product that was the subject of the auction at the preset price, and selling the product to the winning bidder at the winning bid price.

Where the option is not exercised before the product auction is won, and the option is to be offered for resale (S12), the option resale process (S13) is carried out. In the option resale process, the option may be bought once more from the initial buyer by the person that posts the highest bid price during a prescribed period using an auction style, as described above. Where an option is obtained through the option resale process, it is determined once again before the product bidding period expires whether or not the option will be exercised (S11).

If the option is not resold, it is deemed discarded (S14) and the winning bid price in the normal product auction is posted on the home page (S16). On the other hand, if the option is exercised before the winning bid is made on the product (S11), the product auction is ended at that moment, even if it is during the product auction period, and the winning bid price is posted on the home page (S16). With this, the option exercise process comes to an end.

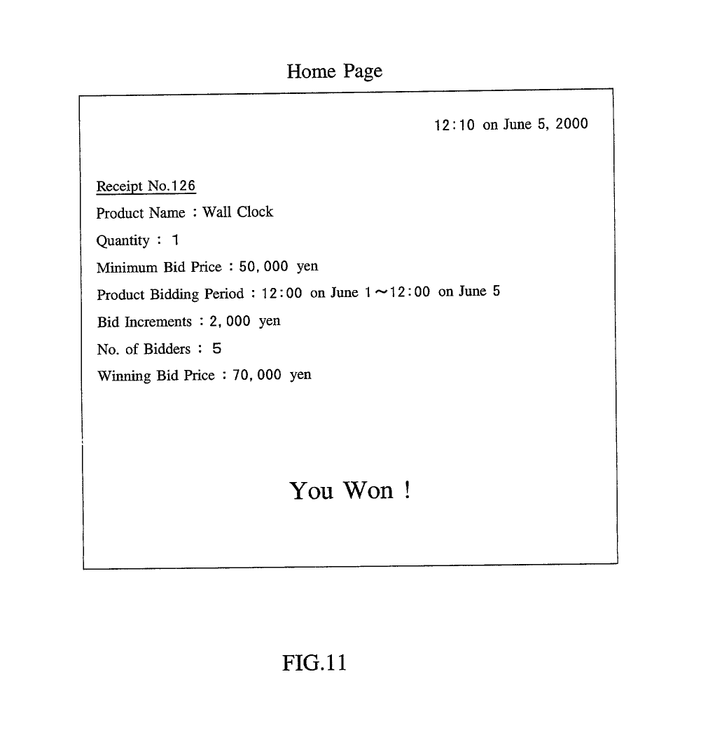

An example of the display screen appearing when a product is won at a product auction will now be explained with reference to FIG. 11. This display screen is displayed in the display of the terminal 3, 4 or 5 or other display means, and the displayed information is generated in the auction processing unit 10 of the server 1. In this display screen, the message ‘You Won!’ is displayed together with information pertaining to the categories of ‘Receipt number’, ‘Product name’, ‘Quantity’, ‘Minimum bid price’, ‘Bidding period’, ‘Bid price increments’, ‘Number of bidders’ and ‘Winning bid price’.

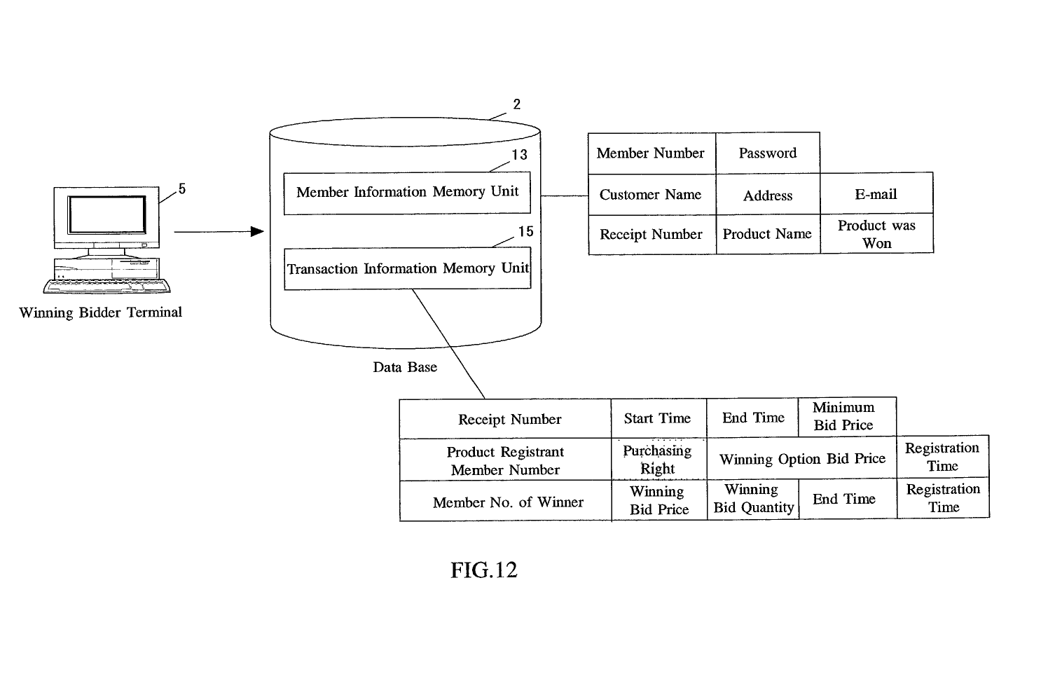

The registration of the winning bidder when a product auction is won will be explained with reference to FIG. 12. In FIG. 12, the contents of the member information memory unit 13 and the transaction information memory unit 15 in the database 2 are shown in detail. When a product is won at auction, the product name of the won product, as well as the fact that the product was won, are added to the member information pertaining to the winning bidder which is stored in the member information memory unit 13.

In the transaction information memory unit 15, in addition to information categorized under ‘Product registrant member number’, ‘Start time’, ‘End time’, ‘Minimum bid price’, ‘Option purchaser member number’, ‘Purchasing right’, ‘Winning option bid price’ and ‘Registration time’, information is also stored regarding the categories of ‘Winning bidder member number’, ‘Winning bid price’, ‘Winning bid quantity’, ‘End time’ and ‘Registration time’. The ‘Winning bidder member number’ is the member number of the person that won the product at the product auction, the ‘Winning bid price’ is the price of the winning bid, the ‘Winning bid quantity’ is the number of items of the product won with the winning bid, ‘End time’ indicates the date and time that the option auction ended, and ‘Registration time’ indicates the date and time that the information on the winning bidder was registered in the transaction information memory unit 15. This information regarding the winning bid is stored in a prescribed area of the transaction information memory unit 15 by the auction processing unit 10.

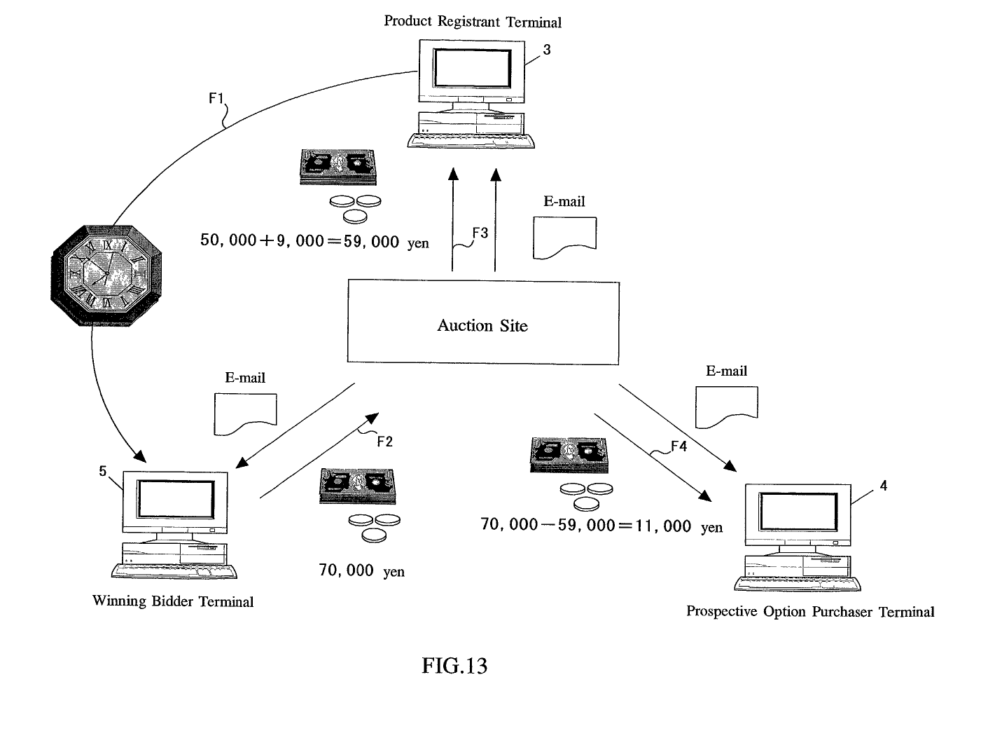

The delivery of the product and the payment that is made after the product auction ends and the winning bid for the product is determined will now be explained with reference to FIG. 13. The minimum bid price for the product and the winning bid price have the same definitions as in the example described above. In the drawing, the auction site comprises the server 1 and the database 2, the repayment processing is executed in the payment processing unit 12, and a record of the payment is stored in the transaction information memory unit 15.

The auction site receives the product from the product registrant and forwards it to the winning bidder (F1 in the drawing). The auction site then notifies the winning bidder via e-mail that it must collect payment for the product, and the winning bidder pays the product purchase price of 70,000 yen (F2 in the drawing).

The auction site then transfers to a pre-designated account belonging to the product registrant the total amount of 5,900 yen representing the 50,000 yen generated through the exercise of the Purchasing right granted in the option and the option sale price of 9,000 yen (F3 in the drawing). The auction site also sends an e-mail notifying the product registrant that the 5,900 yen will be transferred. The auction site further transfers to a pre-designated account belonging to the option purchaser a total of 11,000 yen representing the product sale price of 70,000 yen after deductions of the payment of the 50,000 to be paid to the product registrant under the exercise of the option and the option purchase price of 9,000 yen (F4 in the drawing). The auction site also sends an e-mail notifying the option purchaser that the 11,000 yen will be paid.

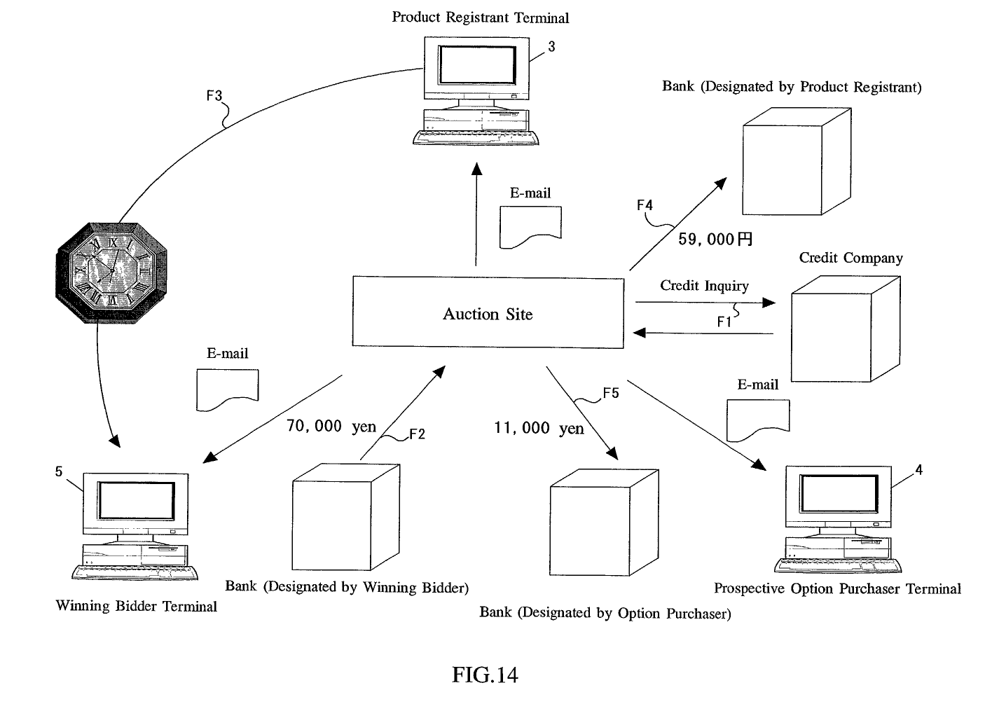

While the payment method shown in FIG. 13 comprises a bank transfer or similar method, a credit payment method may also be used. If this type of payment method is adopted, a new member bank account number and credit number must be registered when a new member is registered. An example of this is shown in FIG. 14.

First, the auction site performs a credit inquiry with a credit company (F1 in the drawing). The credit company receiving this credit inquiry request checks whether the credit card used by the winning bidder is genuine, whether the card is within the credit limit, or whether it is a card that can be used, and transmits the results to the auction site. If it is determined that there are no problems with the card, the auction site collects from the bank account designated by the winning bidder the 70,000 yen representing the winning bid price for the product (F2 in the drawing). The auction site then receives the product from the product registrant and delivers it to the winning bidder using a mail delivery company or a parcel delivery company (F3 in the drawing).

The auction site then transfers 5,900 yen to the bank account previously designated by the product registrant (F4 in the drawing). The auction site also notifies the product registrant via e-mail that the 5,900 yen will be transferred. It then transfers 11,000 yen to the bank account previously designated by the option purchaser (F4 in the drawing). Finally, the auction site notifies the option purchaser by e-mail that the 11,000 yen will be transferred.

### EMBODIMENT 2

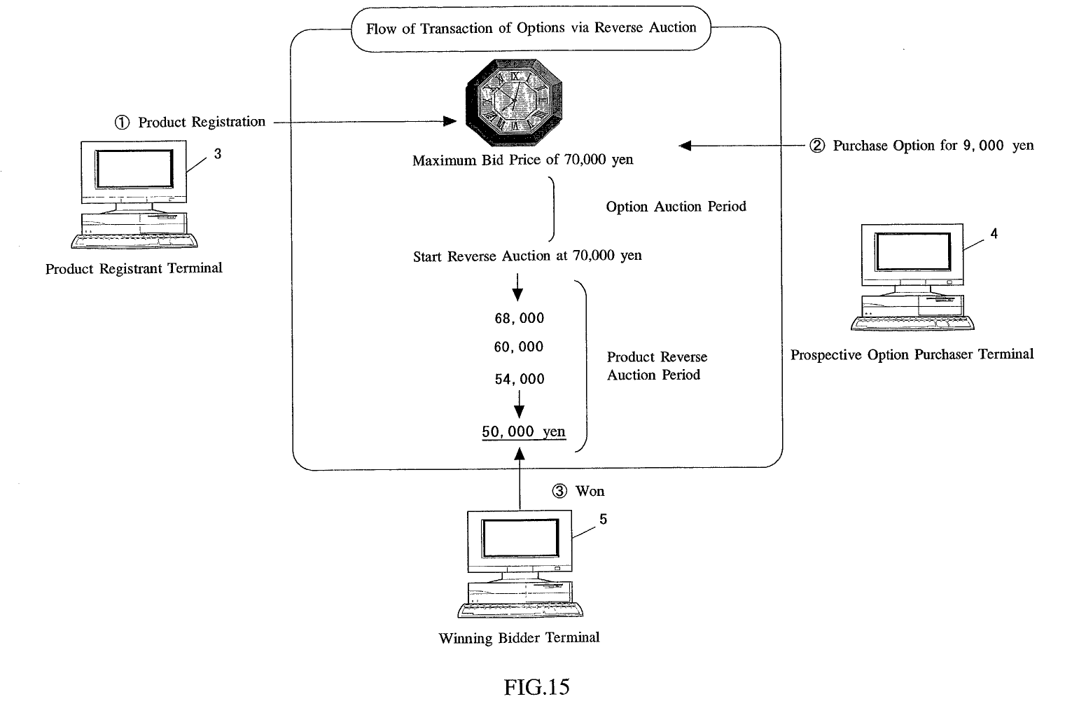

In the Embodiment 2 of the present invention, a transaction system that executes a product transaction via reverse auction will be explained. The basic features of an option transaction based on a reverse auction will be explained with reference to FIG. 15.

First, the product registrant registers product information using his own terminal 3. In this case, the product is a product that the product registrant is interested in buying. In this example, the product registrant designates a wall clock as the subject of a reverse auction, registers a maximum bid price of 70,000 yen, and specifies the quantity, etc. An option auction is then performed, and prospective option purchasers post bids from their respective terminals 4. Bids are posted from a plurality of option purchasers, and ultimately the prospective option purchaser that posts the highest bid wins the option. In this example, the option is won with a bid of 9,000 yen.

Next, a reverse auction of the wall clock comprising the product is carried out. The maximum bid price is the 70,000 specified by the product registrant. An reverse auction is then carried out in which a plurality of bidders post bids using their respective terminals 5. The person that posts the lowest bid price during a prescribed period is deemed the winner, and the wall clock is sold to the product registrant. In this example, the winning bid price is 50,000 yen. If the option purchaser exercises the option within a prescribed period of time after the winning bid is determined, the option purchaser can obtain 70,000 yen from the winning bidder in exchange for the product, because he holds the right to sell the product to the product registrant for 70,000 yen. However, because the option purchase price was 9,000 yen, the difference, or 61,000 yen, is received from the product registrant.

When this type of transaction is carried out, because the product that the option purchaser bought for 50,000 yen was sold for 61,000 yen, he can obtain a profit equal to the difference, or 11,000 yen. On the other hand, the product registrant can obtain the product only by paying to the option purchaser 61,000 yen, representing the difference between the maximum bid price of 70,000 yen and the option premium of 9,000 yen. The sale or exercise of an option makes no difference to the winning bidder for the product, because he won the bidding with a bid of 50,000 yen, received 50,000 yen, and was able to sell the wall clock.

The transaction in the transaction system pertaining to the Embodiment 2 of the present invention differs from the transaction explained with reference to the Embodiment 1 only in that the type of auction in the former case is a reverse auction, while in the latter case it is a normal auction. Since the basic features are otherwise identical, explanation will be omitted.

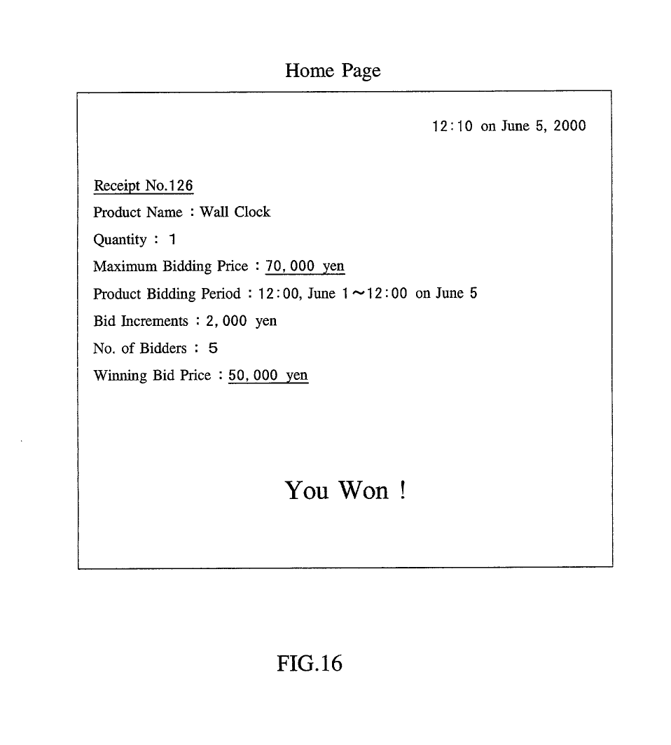

Next, the display screen that appears when the product is won during the product auction will be explained with reference to FIG. 16. This display screen is displayed on the display or other display means belonging to the terminal 3, 4 or 5, and the displayed information is generated in the reverse auction processing unit 11 of the server 1. In this display screen, the message ‘You Won!’ is displayed together with information pertaining to the categories of ‘Receipt number’, ‘Product name’, ‘Quantity’, ‘Maximum bid price’, ‘Bidding period’, ‘Bid price increments’, ‘Number of bidders’ and ‘Winning bid price’.

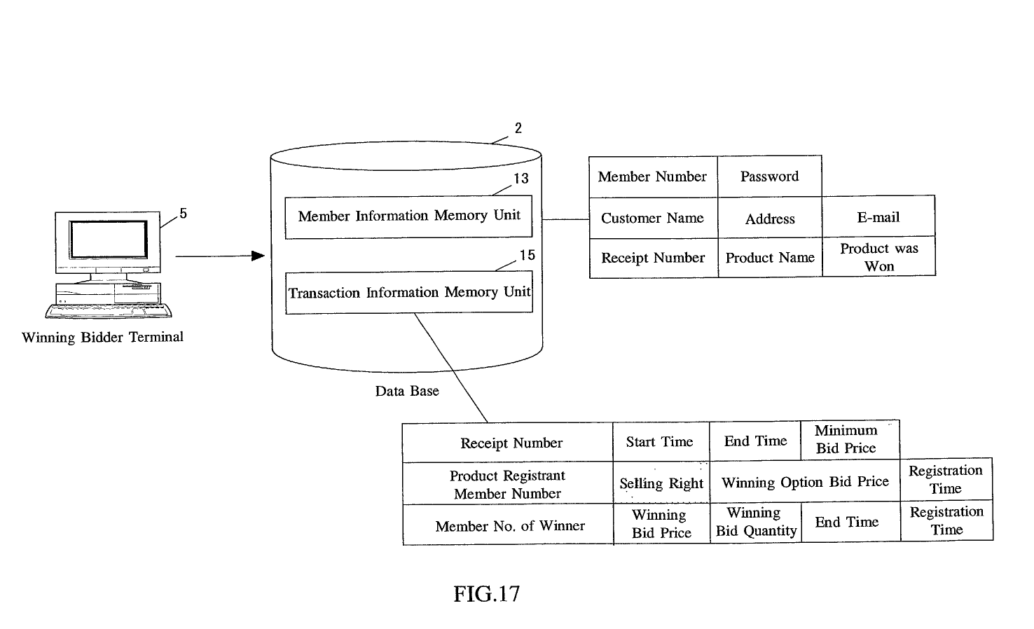

The registration of the winning bidder when a product auction is won will now be explained with reference to FIG. 17. In FIG. 17, the contents of the member information memory unit 13 and the transaction information memory unit 15 in the database 2 are shown in detail. When a product is won at a reverse auction, the product name of the won product, as well as the fact that the product was won, are added to the member information pertaining to the winning bidder which is stored in the member information memory unit 13.

Stored in the transaction information memory unit 15 is information falling under the categories of ‘Product registrant member number’, ‘Start time’, ‘End time’, ‘Maximum bid price’, ‘Option purchaser member number’, ‘Selling right’, ‘Winning option bid price’, ‘Registration time’, ‘Winning bidder member number’, Winning bid price’, ‘Winning bid quantity’, ‘End time’ and ‘Registration time’.

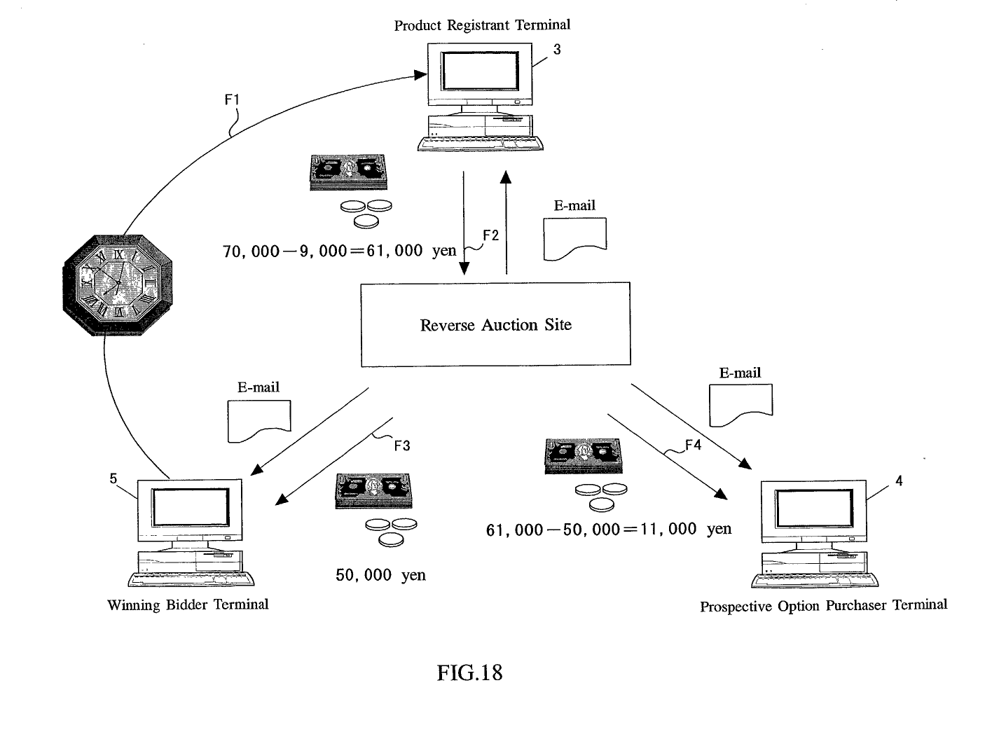

The delivery of the product and the payment that is made after the reverse auction ends and the winning bid for the product is determined will now be explained with reference to FIG. 18. The maximum bid price for the product and the winning bid price have the same definitions as in the example described above. Repayment processing is executed in the payment processing unit 12, and a record of the payment is stored in the transaction information memory unit 15.

The reverse auction site receives the product from the product registrant and forwards it to the winning bidder (F1 in the drawing). The reverse auction site then notifies the product registrant via e-mail that it must collect the difference between the product price and the option price, and the product registrant pays the difference of 61,000 yen (F2 in the drawing).

The reverse auction site then transfers to a pre-designated account belonging to the winning bidder the price of 50,000 yen (F3 in the drawing). The reverse auction site also sends an e-mail notifying the winning bidder that the 50,000 yen will be transferred. The reverse auction site further transfers to a pre-designated account belonging to the option purchaser a total of 11,000 yen representing the product sale price of 70,000 yen after deduction of the 50,000 yen to be paid to the winning bidder and the option purchase price of 9,000 yen (F4 in the drawing). The reverse auction site also sends an e-mail notifying the option purchaser that the 11,000 yen will be paid.

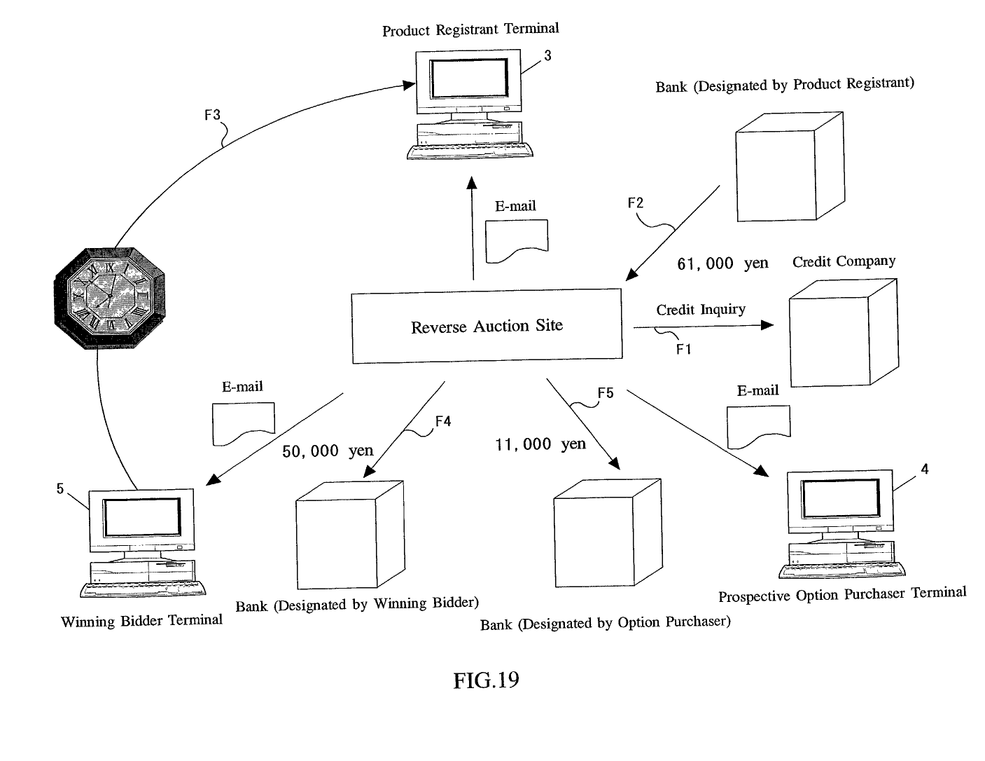

While the payment method shown in FIG. 18 comprises a bank transfer or similar method, a credit payment method may also be used. If this type of payment method is adopted, a new member bank account number and credit number must be registered when a new member is registered. An example of this is shown in FIG. 19.

First, the reverse auction site performs a credit inquiry with a credit company (F1 in the drawing). The credit company receiving this credit inquiry request checks whether the credit card used by the product registrant is genuine, whether the card is within the credit limit, or whether it is a card that can be used, and transmits the results to the reverse auction site. If it is determined that there are no problems with the card, the reverse auction site collects 61,000 yen from the bank account designated by the product registrant (F2 in the drawing). The reverse auction site then receives the product from the winning bidder and delivers it to the product registrant using a mail delivery company or a parcel delivery company (F3 in the drawing).

The reverse auction site then transfers 50,000 yen to the bank account previously designated by the winning bidder (F4 in the drawing). The reverse auction site also notifies the winning bidder via e-mail that the 50,000 yen will be transferred. The reverse auction site then transfers 11,000 yen to the bank account previously designated by the option purchaser (F5 in the drawing). Finally, the auction site notifies the option purchaser by e-mail that the 11,000 yen will be transferred.

In the above examples, the transaction system pertaining to the present invention can be built through storage on a recording medium and sale of a computer program that executes each of the processes in the server 1, and through the installation of the program on a computer by the purchaser of the program. The recording medium may comprise a CD-ROM, a floppy disk, a magnetic tape, a RAM, a ROM, an EPROM, a flash EEPROM, a memory chip, or a cartridge. In addition, the program may be downloaded using a communication network 6 such as the Internet. In this case, the program is temporarily sent through carrier waves.

In the above examples, the purchasing right granted by the option was deemed the right to buy the product that was the subject of the auction at the minimum bid price comprising the initial price when the product auction was opened, but this purchasing right is not limited thereto. In other words, where the minimum bid price is 50,000 yen, the option may confer the right to buy the product for 60,000 yen. Where it is anticipated that the price of the product will rise as a result of the auction, the purchase price set in the option may be higher than the minimum bid price. Conversely, the minimum bid price may be higher than the price set in the option.

In the above examples, registered members were divided into the three classifications of product registrant members, option purchaser members, and product purchaser members, but the present invention is not limited to this implementation. A construction may be adopted in which there is only one type of member, such that once one becomes a member, that member may register products, purchase options or purchase products.

In the above examples, the sale of an option was deemed an essential feature of an auction or a reverse auction, but the present invention is not limited to this implementation, and the sale of an option may be made optional at the time that a product is registered.

In the above examples, all payments were made after the product was won at auction, but the present invention is not limited to this implementation, and the option premium may be made payable immediately after the option sale is concluded.

In the above examples, the option was sold at auction, but the present invention is not limited to this implementation, and the option may instead be sold for a fixed price.

The embodiments of the present invention described above are only specific examples thereof, and all variations that do not deviate from the scope of the present invention are included therein.

Using the present invention, consumers are not limited to the conventional method of participation in an auction or reverse auction, new opportunities to participate in an auction or reverse auction may be provided, and further vitalization of such transactions may be achieved.

While preferred embodiments of the present invention have been described using specific terms, such description is for illustrative purposes only, and it is to be understood that changes and variations may be made without departing from the spirit or scope of the following claims.

What is claimed is:

1. A transaction system in which product auctions are executed over a communication network, comprising:
a product registration processing unit that receives from a product registrant via said communication network information regarding a product to be sold at auction, and stores said information;
an option processing unit that sells to a prospective option purchaser via said communication network an option representing the right to purchase from the product registrant at a preset price the product to be sold at auction, and to sell the product to the winning bidder at the winning bid price; and
an auction processing unit that executes an auction of the product by presenting via said communication network the product information stored by said product registration processing unit and by receiving bids, and where the purchaser of the option requests that the option be exercised, carries out processing in accordance with the terms of the option.

2. A transaction system in which reverse product auctions are executed over a communication network, comprising:
a product registration processing unit that receives from a product registrant via said communication network information regarding a product to be purchased at a reverse auction, and stores said information;
an option processing unit that sells to a prospective option purchaser via said communication network an option representing the right to purchase at the winning bid price the product to be purchased at the reverse auction, and to sell the product to the product registrant at a preset price; and
a reverse auction processing unit that executes a reverse auction of the product by presenting via said communication network the product information stored by said product registration processing unit and by receiving bids, and where the purchaser of the option requests that the option be exercised, carries out processing in accordance with the terms of the option.

3. A transaction system in accordance with claim 1, wherein said option processing unit sells the option in auction style.

4. A transaction system in accordance with claim 2, wherein said option processing unit sells the option in auction style.

5. A transaction system in accordance with claim 1, wherein said option processing unit resells a once-sold option to another person via the communication network.

6. A transaction system in accordance with claim 2, wherein said option processing unit resells a once-sold option to another person via the communication network.

7. A transaction system in accordance with claim 1, further comprising a payment processing unit that implements payment of the product price payable pursuant to the product transaction, as well as payment of the price of the option.

8. A transaction system in accordance with claim 7, wherein said payment processing unit performs a credit inquiry of the product purchaser and implements payment based on the results thereof.

9. A product transaction method that executes product auctions over a communication network, comprising:
a product information processing step in which information regarding a product to be sold at auction is received from a product registrant via said communication network, and said information is stored;
an option processing step in which an option, that represents the right to purchase the product to be sold at auction from the product registrant at a preset price and to sell the product to the winning bidder at the winning bid price, is sold to a prospective option purchaser via said communication network; and
an auction processing step in which an auction of the product is executed by presenting via said communication network the product information stored through said product information processing step and by receiving bids, and where the purchaser of the option requests that the option be exercised, the processing is carried out in accordance with the terms of the option.

10. A product transaction method that executes reverse product auctions over a communication network, comprising:
a product information processing step in which information regarding a product to be purchased at a reverse auction is received from a product registrant via said communication network, and said information is stored;
an option processing step in which an option, that represents the right to purchase at the winning bid price the product to be purchased at the reverse auction and to sell the product to the product registrant at a preset price, is sold to a prospective option purchaser via said communication network; and
a reverse auction processing step in which a reverse auction of the product is executed by presenting via said communication network the product information stored by said product registration processing unit and by receiving bids, and where the purchaser of the option requests that the option be exercised, processing is carried out in accordance with the terms of the option.

11. A product transaction method in accordance with claim 9, wherein said option processing step further comprises a step in which the option is sold in auction style.

12. A product transaction method in accordance with claim 9, wherein said option processing step further comprises a step in which a once-sold option is resold to another person via the communication network.

13. A product transaction method in accordance with claim 9, wherein said method further comprises a payment processing step in which payment of the product price payable pursuant to the product transaction, as well as payment of the price of the option, are implemented.

14. A product transaction method in accordance with claim 13, wherein said payment processing step further comprises a step in which a credit inquiry of the product purchaser is performed and payments are implemented based on the results thereof.

15. A storage medium on which is stored a transaction program that executes product auctions over a communication network by using a computer, wherein said transaction program comprising:
a product information processing step in which information regarding a product to be sold at auction is received from a product registrant via said communication network, and said information is stored;
an option processing step in which an option, that represents the right to purchase from the product registrant at a preset price the product to be sold at auction and to sell the product to the winning bidder at the winning bid price, is sold to a prospective option purchaser via said communication network; and
an auction processing step in which an auction of the product is executed by presenting the product information stored in said product information processing step via said communication network and by receiving bids, and where the purchaser of the option requests that the option be exercised, processing is carried out in accordance with the terms of the option.
